(19) United States
(12) Patent Application Publication
(10) Pub. No.: US 2024/0264793 A1
(43) Pub. Date: Aug. 8, 2024

(54) ACTIVITY-BASED SELECTION OF SHARABLE CONTENT IN A SCREEN-SHARING SESSION

(71) Applicant: International Business Machines Corporation, Armonk, NY (US)

(72) Inventors: Paritosh Ranjan, Kolkata (IN); Prosanta Saha, Kolkata (IN); Bhubaneswar PADHAN, Kolkata (IN); Prodip ROY, Kolkata (IN)

(73) Assignee: International Business Machines Corporation, Armonk, NY (US)

(21) Appl. No.: 18/106,119

(22) Filed: Feb. 6, 2023

(51) Int. Cl. G06F 3/14; H04N 7/15

(52) U.S. Cl. CPC G06F 3/1462; H04N 7/15

(57) ABSTRACT

An embodiment includes determining a first activity value by comparing frames of a first sharable video stream received from a first device associated with a first participant of a screen sharing session. The embodiment also includes generating a first ranked list of activity values, the first ranked list including the first activity value. The embodiment also includes identifying the first activity value as a highest ranking activity value in the first ranked list of activity values. The embodiment also includes transmitting, responsive to identifying the first activity value as the highest ranking activity value, the first sharable content to participants of the screen sharing session.

### BACKGROUND

The present invention relates generally to management of screen-sharing sessions. More particularly, the present invention relates to a method, system, and computer program for activity-based selection of sharable content in a screen-sharing session.

Web conferences continue to become an increasingly popular way for two or more individuals to communicate over long distances. Web conferences may be enabled by a variety of different web conference applications. In general, web conferencing applications allow users to engage in audio and/or video conferencing, share files, presentations, virtual white boards, desktops, and other data while simultaneously conducting voice communications.

A person wishing to host a web conference (the “host”) operates web conferencing software to create and send conference invitations to intended meeting participants (“users”). Once a user is connected to the conference, the user may be granted permission to share their screen with other conference participants. If the user shares their screen with other conference participant's computers, the web conferencing application establishes a digital video stream of content of the user's computer display to others in real-time. When screen sharing, a user often has the option to specify whether the entire display is shared, or only a specified window or application is shared.

### SUMMARY

The illustrative embodiments provide for activity-based selection of sharable content. An embodiment includes determining a first activity value by comparing frames of a first sharable video stream received from a first device associated with a first participant of a screen sharing session. The embodiment also includes generating a first ranked list of activity values, the first ranked list including the first activity value. The embodiment also includes identifying the first activity value as a highest ranking activity value in the first ranked list of activity values. The embodiment also includes transmitting, responsive to identifying the first activity value as the highest ranking activity value, the first sharable content to participants of the screen sharing session. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example cloud computing environment that allows for screen sharing between multiple user devices A-C in accordance with an illustrative embodiment;

FIG. 3 depicts a block diagram of another example cloud computing environment that allows for screen sharing between multiple user devices A-C in accordance with an illustrative embodiment;

FIG. 4 depicts a block diagram of a screen sharing computing environment in accordance with an illustrative embodiment;

FIG. 5 depicts a block diagram of an example screen sharing module in accordance with an illustrative embodiment;

FIG. 6 depicts a flowchart of an example process for activity-based selection of sharable content in a screen-sharing session in accordance with an illustrative embodiment;

FIG. 7 depicts a flowchart of an example process for analyzing frames of video streams to assign respective activity values in accordance with an illustrative embodiment;

FIG. 8 depicts a flowchart of an example process for analyzing frames of video streams to assign respective activity values in accordance with an illustrative embodiment;

FIG. 9 depicts a flowchart of an example process for analyzing frames of video streams to assign respective activity values in accordance with an illustrative embodiment;

FIG. 10 depicts a flowchart of an example process for analyzing frames of video streams to assign respective activity values in accordance with an illustrative embodiment;

FIG. 11 depicts a flowchart of an example process for analyzing frames of video streams to assign respective activity values in accordance with an illustrative embodiment; and

FIG. 12 depicts a flowchart of an example process for analyzing frames of video streams to assign respective activity values in accordance with an illustrative embodiment.

### DETAILED DESCRIPTION

In web conferences and other types of online meetings, a presenter often needs to share content from the screen of their workstation with other meeting attendees in real time. Sometimes, multiple attendees of an online meeting need to share content from their screens, each in turn, at various points and for varying durations. Generally, seamless switching between content of different users' screens is very difficult to achieve as it requires careful coordination between manually stopping the sharing of a current presenter's screen and manually starting the sharing of a next presenter's screen. This manual coordination can be disruptive to an online meeting, especially if there are several presenters necessitating several repetitions of this manual switching process.

Aspects of the present disclosure address the deficiencies described above by providing mechanisms (e.g., systems, methods, machine-readable media, etc.) that include an intelligent screen sharing system for online meetings. An illustrative embodiment intelligently and automatically controls the sharing of screen content among multiple presenters during a screen sharing session. In exemplary embodiments, an intelligent screen sharing system evaluates sharable content from multiple users and selects sharable content having the most meaningful activity being performed.

In exemplary embodiments, the most meaningful activity is detected by detecting activity being performed at the fastest rate. For example, in some embodiments, an intelligent screen sharing system detects most meaningful activity by comparing frames of each sharable video stream received during a window of time.

In exemplary embodiments, an intelligent screen sharing system detects most meaningful activity by comparing transcriptions of frames. In some such embodiments, the intelligent screen sharing system performs an optical character recognition (OCR) process on a first frame resulting in a first transcription. The intelligent screen sharing system then performs an OCR process on a second frame resulting in a second transcription. The intelligent screen sharing system then calculates a Levenshtein distance between the first transcription and the second transcription, where the Levenshtein distance is the absolute value of the difference between the first transcription and the second transcription. In some embodiments, the intelligent screen sharing system calculates Levenshtein distances for a plurality of pairs of frames from each sharable video stream. In some such embodiments, the intelligent screen sharing system calculates a rank for each sharable video stream as a sum of the Levenshtein distances divided by the total number of analyzed frames.

In exemplary embodiments, an intelligent screen sharing system detects most meaningful activity by comparing pixels of frames. In some such embodiments, the intelligent screen sharing system calculates a pixel distance between pixels of a first frame and pixels of a second frame, where the pixel distance is the absolute value of the number of pixels changed between the first frame and the second frame. In some embodiments, the intelligent screen sharing system calculates pixel distances for a plurality of pairs of frames from each sharable video stream. In some such embodiments, the intelligent screen sharing system calculates a rank for each sharable video stream as a sum of the pixel distances divided by the total number of analyzed frames.

In exemplary embodiments, an intelligent screen sharing system detects most meaningful activity by comparing transcriptions of frames. In some such embodiments, the intelligent screen sharing system performs an optical character recognition (OCR) process on a first frame resulting in a first transcription. The intelligent screen sharing system also uses a trained predictive model to classify sets of pixels in the first frame into one of a plurality of predetermined classes associated with respective elements. Examples of such elements may include documents, code editors, command line interfaces, presentations, websites, and diagrams, which are associated with respective element weight values. The intelligent screen sharing system determines an element weight value, or multiple element weight values, of the frames based on the one or more of the element classes in the frames. The intelligent screen sharing system then performs an OCR process on a second frame resulting in a second transcription. The intelligent screen sharing system then calculates a Levenshtein distance between the first transcription and the second transcription, where the Levenshtein distance is the absolute value of the difference between the first transcription and the second transcription. The intelligent screen sharing system then calculates a weighted Levenshtein distance as a product of the Levenshtein distance and the total element weight(s). In some embodiments, the intelligent screen sharing system calculates weighted Levenshtein distances for a plurality of pairs of frames from each sharable video stream. In some such embodiments, the intelligent screen sharing system calculates a rank for each sharable video stream as a sum of the weighted Levenshtein distances divided by the total number of analyzed frames.

In exemplary embodiments, an intelligent screen sharing system detects most meaningful activity by comparing pixels of frames. In some such embodiments, the intelligent screen sharing system calculates a pixel distance between pixels of a first frame and pixels of a second frame, where the pixel distance is the absolute value of the number of pixels changed between the first frame and the second frame. The intelligent screen sharing system also uses a trained predictive model to classify sets of pixels in the first frame and the second frame into one of a plurality of predetermined classes associated with respective elements. Examples of such elements may include documents, code editors, command line interfaces, presentations, websites, and diagrams, which are associated with respective element weight values. In some embodiments, the intelligent screen sharing system calculates weighted pixel distances for a plurality of pairs of frames from each sharable video stream as a product of the pixel distances and the total element weight(s). In some such embodiments, the intelligent screen sharing system calculates a rank for each sharable video stream as a sum of the weighted pixel distances divided by the total number of analyzed frames.

In some embodiments, the intelligent screen sharing system trains a predictive model to classify sets of pixels into one of a plurality of predetermined classes associated with respective application user interfaces. In some embodiments, the predictive model is a machine learning model, such as a neural network. In some embodiments, an intelligent screen sharing system trains the predictive model using training data that includes a plurality of training images for each of a plurality of candidate application user interface classes of variation and each comprising a respective classification label indicating a correct application user interface for the associated training image.

In some embodiments, the intelligent screen sharing system receives selection of plurality of techniques for calculating activity values. The intelligent screen sharing system calculates a plurality of preliminary activity values using respective selected techniques. The intelligent screen sharing system retrieves stored weights associated with respective selected techniques. The intelligent screen sharing system then calculates a weighted average of preliminary activity values as final activity value.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

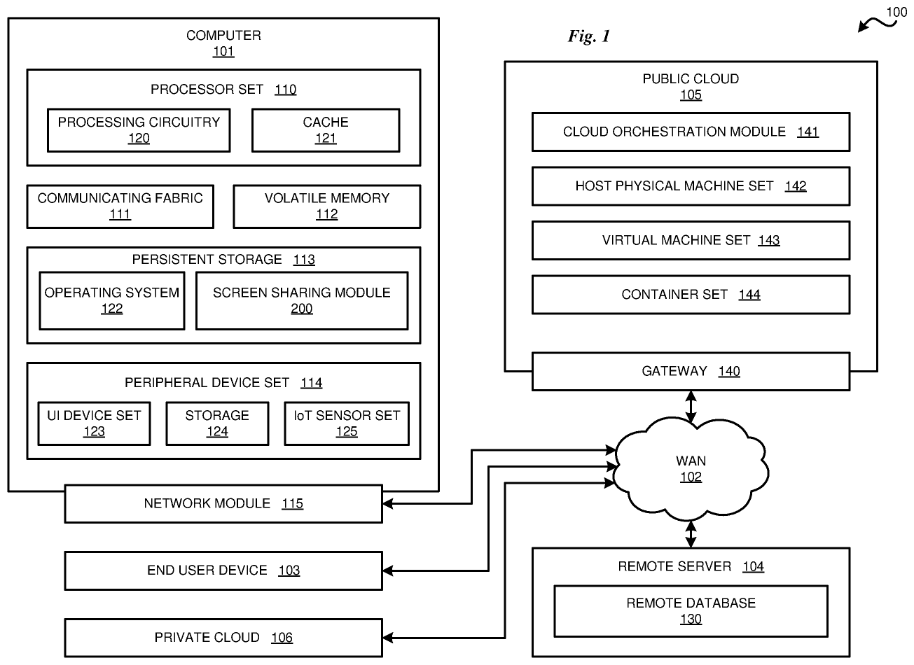

With reference to FIG. 1, this figure depicts a block diagram of a computing environment 100. Computing environment 100 contains an example of an environment for the execution of at least some of the computer code involved in performing the inventive methods, such as an improved screen sharing module 200 that performs activity-based selection of sharable content in a screen-sharing session. In addition to screen sharing module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and screen sharing module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in screen sharing module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in screen sharing module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

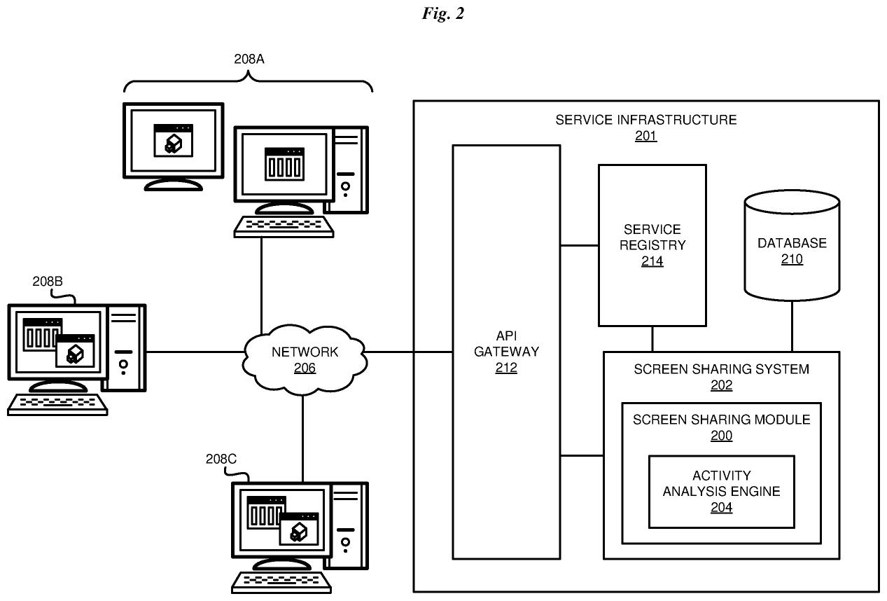

With reference to FIG. 2, this figure depicts a block diagram of an example cloud computing environment that allows for screen sharing between multiple user devices 208A-208C in accordance with an illustrative embodiment. In the illustrated embodiment, a service infrastructure 201 includes a screen sharing system 202, which comprises the screen sharing module 200 of FIG. 1.

In the illustrated embodiment, the user devices 208A-208C are associated with respective participants of a screen sharing session that is managed by the screen sharing module 200. The user devices 208A-208C communicate with the screen sharing module 200 by connecting with the service infrastructure 201 across one or more networks—shown generally as network 206—via an API gateway 212. In some embodiments, the service infrastructure 201 uses a distributed microservice architecture. In some such embodiments, the screen sharing module 200 is a microservices-based application that runs as a distributed system across one or more servers. In various embodiments, service infrastructure 201 and its associated screen sharing system 202 serve multiple users and multiple tenants. A tenant is a group of users (e.g., a company) who share a common access with specific privileges to the software instance. Service infrastructure 201 ensures that tenant specific data is isolated from other tenants.

In some embodiments, user devices 208A-208C connect with API gateway 210 via any suitable network or combination of networks such as the Internet, etc. and use any suitable communication protocols such as Wi-Fi, Bluetooth, etc. Service infrastructure 201 may be built on the basis of cloud computing. API gateway 212 provides access to client applications like screen sharing system 202.

API gateway 212 receives service requests issued by client applications, and creates service lookup requests based on service requests. As a non-limiting example, in an embodiment, one or more of the user devices 208A-208C execute a routine to initiate a request to the screen sharing system 202 for screen sharing processing. For example, in some embodiments, one or more of the user devices 208A-208C provide respective instances of sharable content streams, and the screen sharing module 200 evaluates the received instances of sharable content streams and selects one of the instances as the shared content by detecting the instance having the most meaningful activity being performed. In the illustrated embodiment, the screen sharing module 200 comprises an activity analysis engine 204 that evaluates each of the received instances of sharable content streams and assigns an activity value to each instance that is indicative of the activity being depicted in the respective streams. In exemplary embodiments, the screen sharing module 200 detects the most meaningful activity by detecting activity being performed at the fastest rate. In such embodiments, the activity analysis engine 204 evaluates the instances of sharable content streams by comparing frames of each instance sharable video stream received during a prescribed window of time.

In the illustrated embodiment, the service infrastructure 201 also includes, or is otherwise associated with, a database 210 that comprises at least one computer readable storage medium that stores computer readable program instructions (e.g., computer readable program instructions can include, but are not limited to, instructions for performing processes disclosed herein), and can store any data generated and/or used by screen sharing system 202 and associated components. In some embodiments, the screen sharing system 202 is an example of the computer 101 of FIG. 1 and includes processing circuitry such as processing circuitry 120 that executes computer readable program instructions.

In the illustrated embodiment, service infrastructure 201 includes a service registry 214. In some embodiments, service registry 214 looks up service instances of screen sharing system 202 in response to a service lookup request such as one from API gateway 212 in response to a service request from user devices 208A-208C. For example, in some embodiments, the service registry 214 looks up service instances of screen sharing system 202 in response to requests related to clustering processing from the user devices 208A-208C.

In some embodiments, the service infrastructure 201 includes one or more instances of the screen sharing system 202. In some such embodiments, each of the multiple instances of the screen sharing system 202 run independently as multiple computing systems. In some such embodiments, screen sharing system 202, as well as other service instances of screen sharing system 202, are registered in service registry 214.

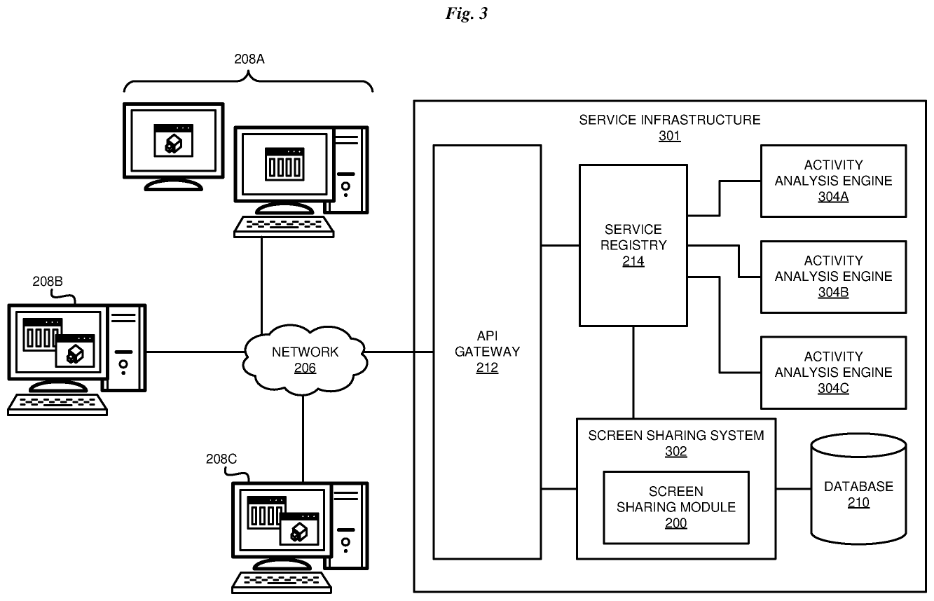

With reference to FIG. 3, this figure depicts a block diagram of another example cloud computing environment that allows for screen sharing between multiple user devices 208A-208C in accordance with an illustrative embodiment. In the illustrated embodiment, a service infrastructure 301 includes a screen sharing system 202, which comprises the screen sharing module 200 of FIG. 1, as well as a plurality of activity analysis engines 304A-304C.

In the illustrated embodiment, the user devices 208A-208C are associated with respective participants of a screen sharing session that is managed by the screen sharing module 200. The user devices 208A-208C communicate with the screen sharing module 200 by connecting with the service infrastructure 301 across one or more networks—shown generally as network 206—via an API gateway 212. In some embodiments, the service infrastructure 301 uses a distributed microservice architecture. In some such embodiments, the screen sharing module 200 is a microservices-based application that runs as a distributed system across one or more servers. In various embodiments, service infrastructure 301 and its associated screen sharing system 202 serve multiple users and multiple tenants. A tenant is a group of users (e.g., a company) who share a common access with specific privileges to the software instance. Service infrastructure 301 ensures that tenant specific data is isolated from other tenants.

In some embodiments, user devices 208A-208C connect with API gateway 210 via any suitable network or combination of networks such as the Internet, etc. and use any suitable communication protocols such as Wi-Fi, Bluetooth, etc. Service infrastructure 301 may be built on the basis of cloud computing. API gateway 212 provides access to client applications like screen sharing system 202.

API gateway 212 receives service requests issued by client applications, and creates service lookup requests based on service requests. As a non-limiting example, in an embodiment, one or more of the user devices 208A-208C execute a routine to initiate a request to the screen sharing system 202 for screen sharing processing. For example, in some embodiments, one or more of the user devices 208A-208C provide respective instances of sharable content streams, and the screen sharing module 200 evaluates the received instances of sharable content streams and selects one of the instances as the shared content by detecting the instance having the most meaningful activity being performed. In the illustrated embodiment, the screen sharing module 200 communicates with activity analysis engines 304A-304C that provide distributed evaluation of each of the received instances of sharable content streams and assign respective activity values to each instance that is indicative of the activity being depicted in the respective streams.

In some such embodiments, the screen sharing module 200 directs each of the received instances of sharable content streams to the activity analysis engines 304A-304C for evaluation. In some embodiments, the screen sharing module 200 also monitors workloads of the activity analysis engines 304A-304C and selects from among the activity analysis engines 304A-304C according to workloads to maintain balanced workloads among the activity analysis engines 304A-304C to the extent possible. In some embodiments, the number of activity analysis engines 304A-304C varies according to number of participants providing sharable content. As the number of instances of sharable content increases, the screen sharing module 200 may initiate a routine to generate one or more additional instances of the activity analysis engine 304 to keep up with the work load. Similarly, if the number of instances of received sharable content decreases, the screen sharing module 200 may shut down instances of the activity analysis engine 304 that are not needed to keep up with the work load.

In exemplary embodiments, the screen sharing module 200 detects the most meaningful activity by detecting activity being performed at the fastest rate. In such embodiments, the activity analysis engines 304A-304C evaluate the instances of sharable content streams by comparing frames of each instance sharable video stream received during a prescribed window of time.

In the illustrated embodiment, the service infrastructure 301 also includes, or is otherwise associated with, a database 210 that comprises at least one computer readable storage medium that stores computer readable program instructions (e.g., computer readable program instructions can include, but are not limited to, instructions for performing processes disclosed herein), and can store any data generated and/or used by screen sharing system 202 and associated components. In some embodiments, the screen sharing system 202 is an example of the computer 101 of FIG. 1 and includes processing circuitry such as processing circuitry 120 that executes computer readable program instructions.

In the illustrated embodiment, service infrastructure 301 includes a service registry 214. In some embodiments, service registry 214 looks up service instances of screen sharing system 202 in response to a service lookup request such as one from API gateway 212 in response to a service request from user devices 208A-208C. For example, in some embodiments, the service registry 214 looks up service instances of screen sharing system 202 in response to requests related to clustering processing from the user devices 208A-208C.

In some embodiments, the service infrastructure 301 includes one or more instances of the screen sharing system 202. In some such embodiments, each of the multiple instances of the screen sharing system 202 run independently as multiple computing systems. In some such embodiments, screen sharing system 202, as well as other service instances of screen sharing system 302, are registered in service registry 214.

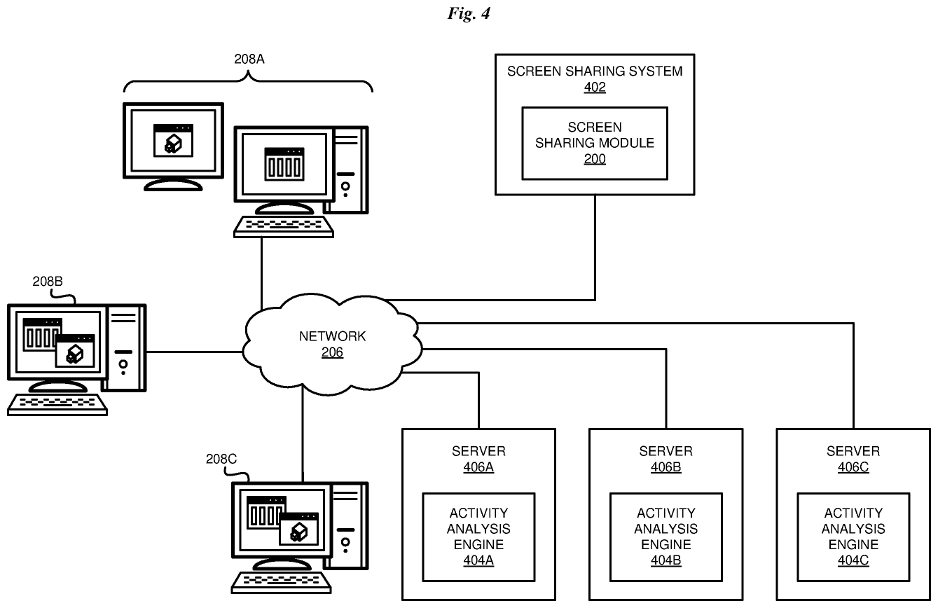

With reference to FIG. 4, this figure depicts a block diagram of a screen sharing computing environment in accordance with an illustrative embodiment. In a particular embodiment, a screen sharing system 402 includes the screen sharing module 200 of FIG. 1. In some embodiments, the screen sharing system 402 is an example of the computer 101 of FIG. 1.

In the illustrated embodiment, the user devices 208A-208C are associated with respective participants of a screen sharing session that is managed by the screen sharing module 200. The user devices 208A-208C communicate with the screen sharing module 200 by connecting with the screen sharing system 402, which is a network accessible device such as a server. In various embodiments, the screen sharing system 402 is a server configured to serve multiple users.

In some embodiments, user devices 208A-208C connect with screen sharing system 402 via any suitable network 206 or combination of networks such as the Internet, etc. and use any suitable communication protocols such as Wi-Fi, Bluetooth, etc. The screen sharing system 402 comprises the screen sharing module 200 that manages received requests from one or more of the user devices 208A-208C for screen sharing processing. For example, in some embodiments, one or more of the user devices 208A-208C provide respective instances of sharable content streams, and the screen sharing module 200 evaluates the received instances of sharable content streams and selects one of the instances as the shared content by detecting the instance having the most meaningful activity being performed.

In the illustrated embodiment, the screen sharing module 200 communicates with activity analysis engines 404A-404C on respective servers 406A-406C. The activity analysis engines 404A-404C provide distributed evaluation of each of the received instances of sharable content streams and assign respective activity values to each instance that is indicative of the activity being depicted in the respective streams. In some such embodiments, the screen sharing module 200 directs each of the received instances of sharable content streams to the activity analysis engines 404A-404C for evaluation. In some embodiments, the screen sharing module 200 also monitors workloads of the activity analysis engines 404A-404C and selects from among the activity analysis engines 404A-404C according to work loads to maintain balanced workloads among the activity analysis engines 404A-404C to the extent possible. In some embodiments, the number of activity analysis engines 404A-404C varies according to number of participants providing sharable content. As the number of instances of sharable content increases, the screen sharing module 200 may initiate a routine to generate one or more additional instances of the activity analysis engine 404 to keep up with the work load. Similarly, if the number of instances of received sharable content decreases, the screen sharing module 200 may shut down instances of the activity analysis engine 404 that are not needed to keep up with the work load.

In exemplary embodiments, the screen sharing module 200 detects the most meaningful activity by detecting activity being performed at the fastest rate. In such embodiments, the activity analysis engines 404A-404C evaluate the instances of sharable content streams by comparing frames of each instance sharable video stream received during a prescribed window of time.

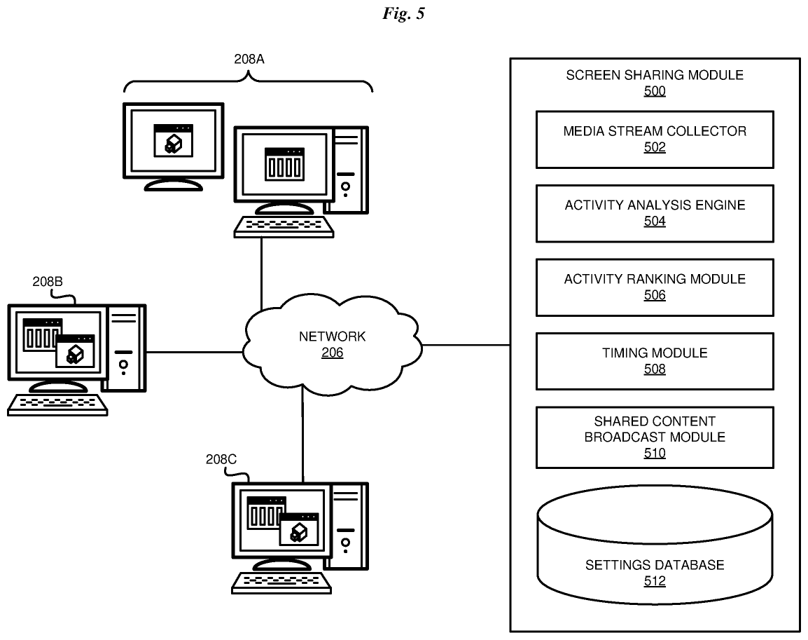

With reference to FIG. 5, this figure depicts a block diagram of an example screen sharing module 500 in accordance with an illustrative embodiment. In a particular embodiment, the screen sharing module 500 is an example of the screen sharing module 200 of FIG. 1.

In some embodiments, the data leak detection module 500 includes a media stream collector 502, an activity analysis engine 504, an activity ranking module 506, a timing module 508, a shared content broadcast module 510, and a settings database 512. In alternative embodiments, the screen sharing module 500 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, during a web conference or other such online meeting during which participants associated with the user devices 208A-208C may wish to share their on-screen content, the media stream collector 502 receives instances of sharable video streams from one or more of the user devices 208A-208C. The media stream collector 502 provides the received instances to the activity analysis engine 504.

In the illustrated embodiment, when the activity analysis engine 504 receives the instances of sharable video streams from the media stream collector 502, the activity analysis engine 504 analyses specified frames of each instance to assign respective activity values indicative of activity being performed. The activity analysis engine 504 provides the activity values to the activity ranking module 506. The activity ranking module 506 compares the activity values and identifies the instance having the highest activity value. The activity ranking module 506 then notifies the shared content broadcast module 510 of the one of the user devices 208A-208C that is the source of the instance of the sharable video stream having the highest activity value. The shared content broadcast module 510 then begins providing the sharable video stream associated with the highest activity value with the user devices 208A-device 208C.

The activity ranking module 506 also notifies the timing module 508, which keeps track of the amount of time that has passed since a source of shared content was last selected. In some embodiments, the screen sharing module 500 evaluates instances of sharable video streams, and potentially changes which of the user devices 208A-208C is the current presenter, at regular time intervals according to a designated amount of time, referred to as the render delay. The presenter change performed by the screen sharing module 500 uses the render delay as a minimum time delay between changes to the presenter to ensure that the content displayed to the user devices 208A-208C does not flicker continuously and becomes useless. In some embodiments, the render delay has a default time value configured, e.g., 10 seconds. In some embodiments, a user such as an administrator is able to change the minimum delay to any other duration i.e., 30 seconds or 1 minute, which is stored in the settings database 512 with other user preferences.

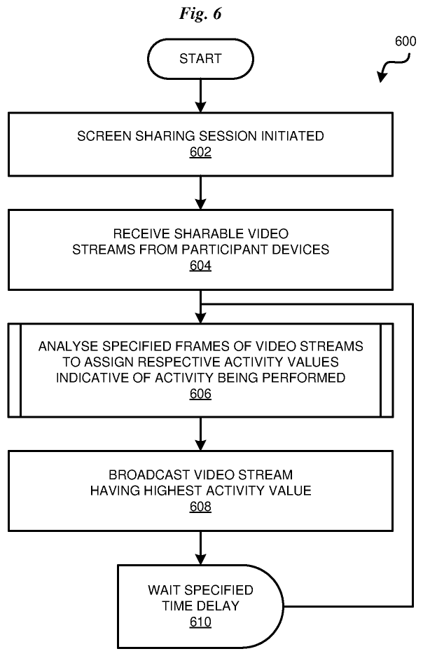

With reference to FIG. 6, this figure depicts a flowchart of an example process 600 for activity-based selection of sharable content in a screen-sharing session in accordance with an illustrative embodiment. In a particular embodiment, the screen sharing module 200 of FIGS. 1-4 or screen sharing module 500 of FIG. 5 carries out the process 600.

At block 602, a screen sharing session is initiated. Next, at block 604, the process receives sharable video streams from participant devices. In some embodiments, one or more participants in an online meeting may designate their screens, or a portion thereof, as being available as sharable content that can be shared with other participants.

Next, at block 606, the process analyses specified frames of video streams to assign respective activity values indicative of activity being performed. In some embodiments, the process at block 606 processes each sharable video stream independently. The process analyses every n^{th} and (n+n)^{th} frame pair, where n is a frame delay and may be any integer having a minimum value of 1. A higher value of n would require low computational processing requirements to perform this analysis, but with comparatively lower precision. A lower value of n would require higher computational processing but will provide high precision analysis.

Next, at block 608, the process broadcasts video stream having highest activity value. Next, at block 610, the process waits a period of time according to a specified time delay, then repeats the process for the duration of the screen sharing session. The time delay is the minimum amount of delay before the screen shared/presenter can be changed by the system, to avoid flickering on the screen that may otherwise be caused by rapid changing of the presenter. In some embodiments, the time delay can be adjusted as a user setting.

In some embodiments, the number of frame pairs that are analyzed at block 606 depends on the frame rate of the sharable video (in frames per second (fps)), frame delay n, and the time delay at block 610. For example, if the frame rate of the sharable video is 10 fps, the frame delay n is 20 frames, and the time delay is 5 s, during the 5 s time delay the sharable content will span 50 frames. The frame delay of 20 frames means the process will start with frame 1, then collect frame 21 for comparison to frame 1, and then collect frame 41 for comparison to frame 21, so the process at block 606 will have two rank values for each sharable content stream. In such an embodiment, the process would average the two rank values of each sharable content stream to arrive at a final rank for each sharable stream.

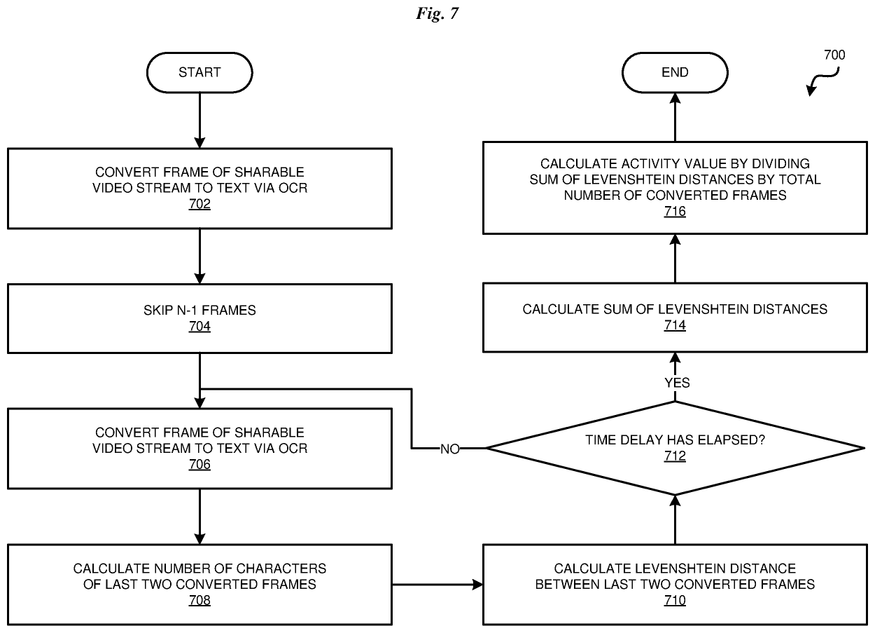

With reference to FIG. 7, this figure depicts a flowchart of an example process 700 for analyzing frames of video streams to assign respective activity values in accordance with an illustrative embodiment. In a particular embodiment, the screen sharing module 200 of FIG. 1, the activity analysis engine 204 of FIG. 2, the activity analysis engines 304A-304C of FIG. 3, the activity analysis engines 404A-404C of FIG. 4, or the activity analysis engine 504 of FIG. 5 carries out the process 700.

At block 702, the process converts a frame of sharable video stream to text via OCR. Next, at block 704, the process skips n-1 frames, where n is a specified frame delay. Next, at block 706, the process converts another frame of sharable video stream to text via OCR. Next, at block 708, the process calculates a number of characters of last two converted frames. Next, at block 710, the process calculates a Levenshtein distance between last two converted frames. Next, at block 712, the process determines whether a specified time delay has elapsed. Next, at block 714, the process calculates a sum of the Levenshtein distances. Next, at block 716, the process calculates an activity value by dividing the sum of the Levenshtein distances by the total number of converted frames.

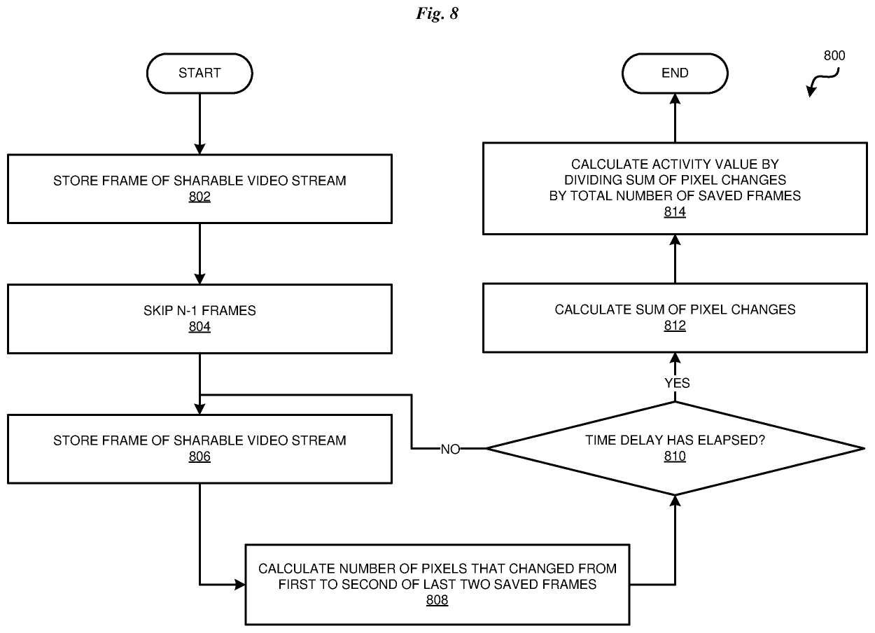

With reference to FIG. 8, this figure depicts a flowchart of an example process 800 for analyzing frames of video streams to assign respective activity values in accordance with an illustrative embodiment. In a particular embodiment, the screen sharing module 200 of FIG. 1, the activity analysis engine 204 of FIG. 2, the activity analysis engines 304A-304C of FIG. 3, the activity analysis engines 404A-404C of FIG. 4, or the activity analysis engine 504 of FIG. 5 carries out the process 800.

At block 802, the process stores a frame of a sharable video stream. Next, at block 804, the process skips n-1 frames, where n is a specified frame delay. Next, at block 806, the process stores another frame of the sharable video stream. Next, at block 808, the process calculates a number of pixels that changed from the first to the second of the last two saved frames. Next, at block 810, the process determines whether a specified time delay has elapsed. Next, at block 812, the process calculates a sum of pixel changes. Next, at block 814, the process calculates an activity value by dividing the sum of the pixel changes by the total number of saved frames.

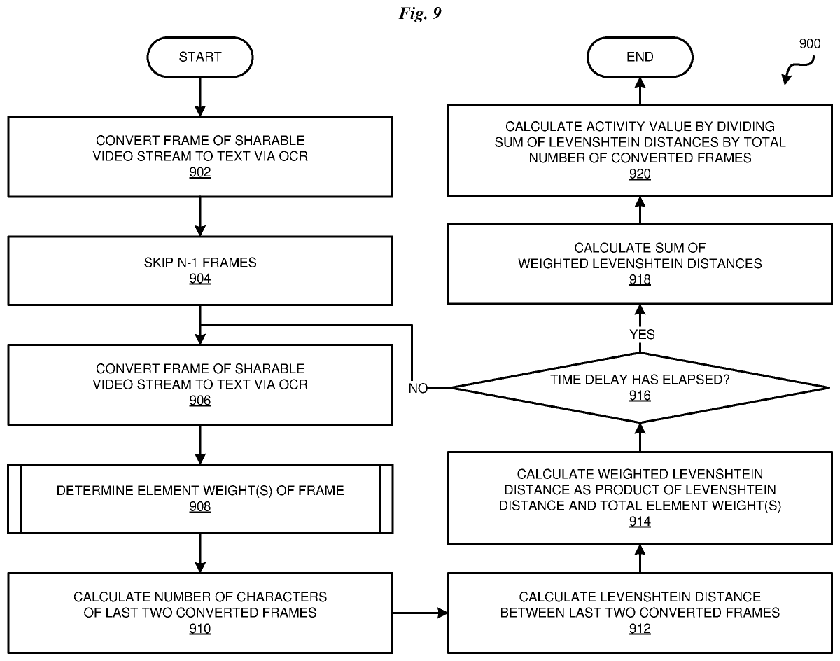

With reference to FIG. 9, this figure depicts a flowchart of an example process 900 for analyzing frames of video streams to assign respective activity values in accordance with an illustrative embodiment. In a particular embodiment, the screen sharing module 200 of FIG. 1, the activity analysis engine 204 of FIG. 2, the activity analysis engines 304A-304C of FIG. 3, the activity analysis engines 404A-404C of FIG. 4, or the activity analysis engine 504 of FIG. 5 carries out the process 900.

At block 902, the process converts a frame of a sharable video stream to text via OCR. Next, at block 904, the process skips n-1 frames, where n is a specified frame delay. Next, at block 906, the process converts another frame of the sharable video stream to text via OCR. Next, at block 908, the process determines an element weight value, or multiple element weight values, of the frames. Next, at block 910, the process calculates a number of characters in each of the last two converted frames. Next, at block 912, the process calculates a Levenshtein distance between the last two converted frames. Next, at block 914, the process calculates a weighted Levenshtein distance as a product of the Levenshtein distance and the total element weight(s). Next, at block 916, the process determines if a specified time delay has elapsed. Next, at block 918, the process calculates a sum of weighted Levenshtein distances. Next, at block 920, the process calculates an activity value by dividing the sum of weighted Levenshtein distances by the total number of converted frames.

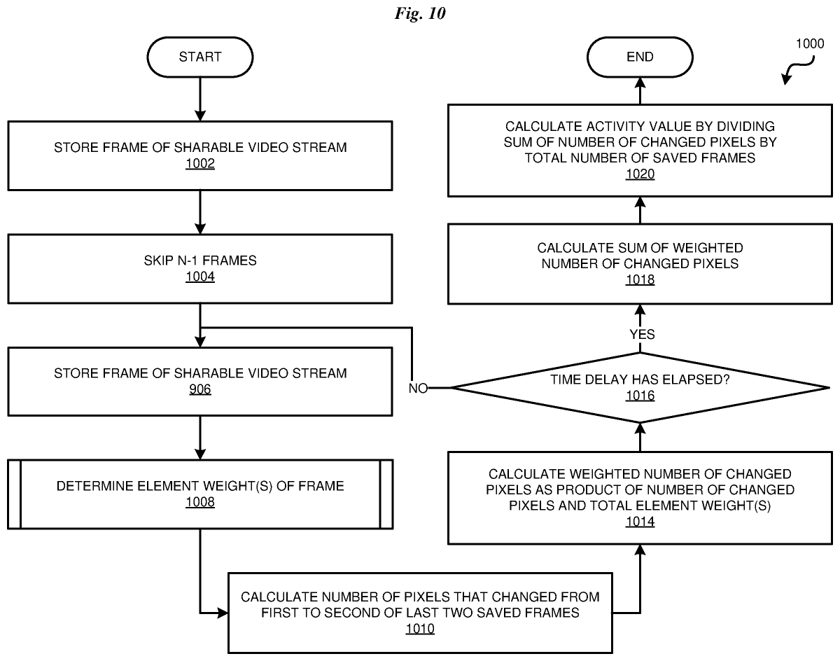

With reference to FIG. 10, this figure depicts a flowchart of an example process 1000 for analyzing frames of video streams to assign respective activity values in accordance with an illustrative embodiment. In a particular embodiment, the screen sharing module 200 of FIG. 1, the activity analysis engine 204 of FIG. 2, the activity analysis engines 304A-304C of FIG. 3, the activity analysis engines 404A-404C of FIG. 4, or the activity analysis engine 504 of FIG. 5 carries out the process 1000.

At block 1002, the process store frame of sharable video stream. Next, at block 1004, the process skips n-1 frames. Next, at block 1006, the process store frame of sharable video stream. Next, at block 1008, the process determines element weight(s) of a frame. Next, at block 1010, the process calculates a number of pixels that changed from first to second of last two saved frames. Next, at block 1014, the process calculates a weighted number of changed pixels as product of number of changed pixels and total element weight(s). Next, at block 1016, the process determines whether a specified time delay has elapsed. Next, at block 1018, the process calculates a sum of weighted numbers of changed pixels. Next, at block 1020, the process calculates an activity value by dividing the sum of weighted numbers of changed pixels by the total number of saved frames.

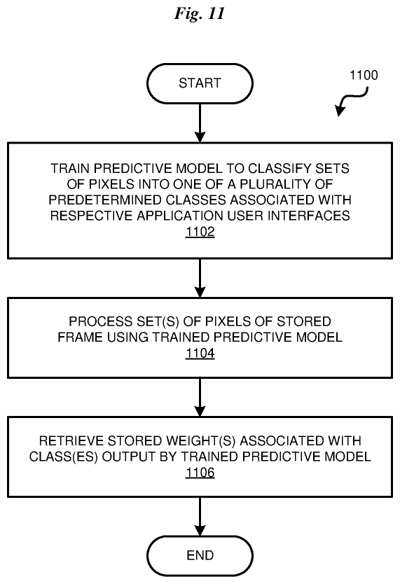

With reference to FIG. 11, this figure depicts a flowchart of an example process 1100 for analyzing frames of video streams to assign respective activity values in accordance with an illustrative embodiment. In a particular embodiment, the screen sharing module 200 of FIG. 1, the activity analysis engine 204 of FIG. 2, the activity analysis engines 304A-304C of FIG. 3, the activity analysis engines 404A-404C of FIG. 4, or the activity analysis engine 504 of FIG. 5 carries out the process 1100.

At block 1102, the process trains predictive a model to classify sets of pixels into one of a plurality of predetermined classes associated with respective application user interfaces. Next, at block 1104, the process processes set(s) of pixels of stored frame using trained predictive model. Next, at block 1106, the process retrieves stored weight(s) associated with class(es) output by trained predictive model.

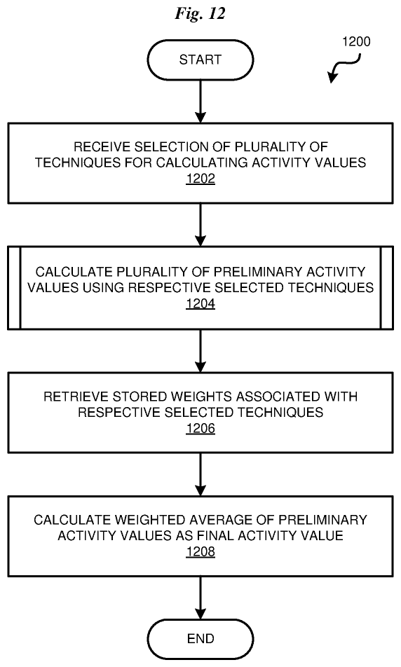

With reference to FIG. 12, this figure depicts a flowchart of an example process 1200 for analyzing frames of video streams to assign respective activity values in accordance with an illustrative embodiment. In a particular embodiment, the screen sharing module 200 of FIG. 1, the activity analysis engine 204 of FIG. 2, the activity analysis engines 304A-304C of FIG. 3, the activity analysis engines 404A-404C of FIG. 4, or the activity analysis engine 504 of FIG. 5 carries out the process 1200.

At block 1202, the process receives selection of plurality of techniques for calculating activity values. Next, at block 1204, the process calculates a plurality of preliminary activity values using respective selected techniques. Next, at block 1206, the process retrieves stored weights associated with respective selected techniques. Next, at block 1208, the process calculates a weighted average of preliminary activity values as final activity value.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining a first activity value by comparing frames of a first sharable video stream received from a first device associated with a first participant of a screen sharing session;
generating a first ranked list of activity values, the first ranked list including the first activity value;
identifying the first activity value as a highest ranking activity value in the first ranked list of activity values; and
transmitting, responsive to identifying the first activity value as the highest ranking activity value, the first sharable content to participants of the screen sharing session.

2. The computer-implemented method according to claim 1, further comprising:
determining a second activity value by comparing frames of a second sharable video stream received from a second device associated with a second participant of the screen sharing session, wherein the first ranked list includes the second activity value.

3. The computer-implemented method according to claim 2, wherein the determining of the first and second activity values occurs during a first window of time.

4. The computer-implemented method according to claim 3, further comprising:
determining, during a second window of time subsequent to the first window of time, a third activity value by comparing frames of the first sharable video stream received from the first device associated with the first participant of the screen sharing session;
determining, during the second window of time, a fourth activity value by comparing frames of the second sharable video stream received from the second device associated with the second participant of the screen sharing session;
generating a second ranked list of activity values, the second ranked list including the third and fourth activity values;
identifying the fourth activity value as a highest ranking activity value in the second ranked list of activity values; and
transmitting, responsive to identifying the fourth activity value as the highest ranking activity value, the second sharable content to participants of the screen sharing session.

5. The computer-implemented method according to claim 3, wherein the comparing of the frames of the first sharable video stream comprises comparing frames received during the first window of time, wherein the frames comprise a first frame and a second frame, the first and second frames being separated by a predetermined number of frames.

6. The computer-implemented method according to claim 5, wherein the frames received during the first window of time further comprise third and fourth frames separated by the predetermined number of frames, wherein the comparing of the frames of the first sharable video stream further comprises comparing the third and fourth frames.

7. The computer-implemented method according to claim 5, wherein the comparing of the frames of the first sharable video stream comprises:
performing an optical character recognition (OCR) process on the first frame resulting in a first transcription;
performing the OCR process on the second frame resulting in a second transcription; and
comparing the first transcription to the second transcription.

8. The computer-implemented method according to claim 7, wherein the first activity value is based at least in part on a Levenshtein distance between the first transcription and the second transcription.

9. The computer-implemented method according to claim 7, wherein the comparing of the frames of the first sharable video stream further comprises:
classifying, using a predictive model, a set of pixels of the first frame into a predicted class, wherein the predicted class is one of a plurality of predetermined classes associated with respective application user interfaces; and
assigning a weight value to the first frame based at least on part on the predicted class of the set of pixels.

10. The computer-implemented method according to claim 5, wherein the comparing of the frames of the first sharable video stream comprises comparing a first set of pixels of the first frame to a second set of pixels of the second frame, thereby determining a number of pixels that have changed from the first frame to the second frame.

11. The computer-implemented method according to claim 10, wherein the first activity value is based at least in part on the number of pixels that have changed from the first frame to the second frame.

12. The computer-implemented method according to claim 10, wherein the comparing of the frames of the first sharable video stream further comprises:
classifying, using a predictive model, a set of pixels of the first frame into a predicted class, wherein the predicted class is one of a plurality of predetermined classes associated with respective application user interfaces; and
assigning a weight value to the first frame based at least on part on the predicted class of the set of pixels.

13. A computer program product comprising one or more computer readable storage media, and program instructions collectively stored on the one or more computer readable storage media, the program instructions executable by a processor to cause the processor to perform operations comprising:
determining a first activity value by comparing frames of a first sharable video stream received from a first device associated with a first participant of a screen sharing session;
generating a first ranked list of activity values, the first ranked list including the first activity value;
identifying the first activity value as a highest ranking activity value in the first ranked list of activity values; and
transmitting, responsive to identifying the first activity value as the highest-ranking activity value, the first sharable content to participants of the screen sharing session.

14. The computer program product of claim 13, wherein the stored program instructions are stored in a computer readable storage device in a data processing system, and wherein the stored program instructions are transferred over a network from a remote data processing system.

15. The computer program product of claim 13, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

16. The computer program product of claim 15, further comprising:
determining a second activity value by comparing frames of a second sharable video stream received from a second device associated with a second participant of the screen sharing session, wherein the first ranked list includes the second activity value,
wherein the determining of the first and second activity values occurs during a first window of time.

17. The computer program product of claim 16, further comprising:
determining, during a second window of time subsequent to the first window of time, a third activity value by comparing frames of the first sharable video stream received from the first device associated with the first participant of the screen sharing session;
determining, during the second window of time, a fourth activity value by comparing frames of the second sharable video stream received from the second device associated with the second participant of the screen sharing session;
generating a second ranked list of activity values, the second ranked list including the third and fourth activity values;
identifying the fourth activity value as a highest ranking activity value in the second ranked list of activity values; and
transmitting, responsive to identifying the fourth activity value as the highest ranking activity value, the second sharable content to participants of the screen sharing session.

18. A computer system comprising a processor and one or more computer readable storage media, and program instructions collectively stored on the one or more computer readable storage media, the program instructions executable by the processor to cause the processor to perform operations comprising:
determining a first activity value by comparing [a first pair of] frames of a first sharable video stream received from a first device associated with a first participant of a screen sharing session;
generating a first ranked list of activity values, the first ranked list including the first activity value;
identifying the first activity value as a highest ranking activity value in the first ranked list of activity values; and
transmitting, responsive to identifying the first activity value as the highest ranking activity value, the first sharable content to participants of the screen sharing session.

19. The computer system of claim 18, further comprising:
determining a second activity value by comparing frames of a second sharable video stream received from a second device associated with a second participant of the screen sharing session, wherein the first ranked list includes the second activity value,
wherein the determining of the first and second activity values occurs during a first window of time.

20. The computer system of claim 18, further comprising:
determining, during a second window of time subsequent to the first window of time, a third activity value by comparing frames of the first sharable video stream received from the first device associated with the first participant of the screen sharing session;
determining, during the second window of time, a fourth activity value by comparing frames of the second sharable video stream received from the second device associated with the second participant of the screen sharing session;
generating a second ranked list of activity values, the second ranked list including the third and fourth activity values;
identifying the fourth activity value as a highest ranking activity value in the second ranked list of activity values; and
transmitting, responsive to identifying the fourth activity value as the highest ranking activity value, the second sharable content to participants of the screen sharing session.
